(19) United States
(12) Patent Application Publication
(10) Pub. No.: US 2019/0155938 A1
(43) Pub. Date: May 23, 2019

(54) MULTI-VENDOR SYNCHRONIZATION PLATFORM SUPPORTING MULTIPLE FORMATS

(71) Applicant: salesforce.com, inc., San Francisco, CA (US)

(72) Inventors: Dmytro Kudriavtsev, Belmont, CA (US); Pawan Nachnani, Union City, CA (US); Dmytro Kashyn, Holliston, MA (US); Binyuan Chen, Belmont, CA (US); Satya Venkata Kamuju, Sunnyvale, CA (US); Harini Vaidhyanathan, Sunnyvale, CA (US); Venkata Muralidhar Tejomurtula, Danville, CA (US); Shouzhong Shi, San Jose, CA (US); Ajitesh Jain, San Mateo, CA (US); Prabhjot Singh, Union City, CA (US)

(21) Appl. No.: 16/006,775

(22) Filed: Jun. 12, 2018

Related U.S. Application Data
(60) Provisional application No. 62/588,729, filed on Nov. 20, 2017.

(51) Int. Cl. G06F 17/30; H04L 29/08

(52) U.S. Cl. CPC G06F 17/30575; H04L 67/306; H04L 67/1095

(57) ABSTRACT

In various embodiments, a system of synchronizing data is described. The system may store data associated with a plurality of data vendors. The system may synchronize the stored data with data from a first data vendor. The received data may be parsed by identifying data values indicated by associated metadata, and modifying the data values based on a universal data format. The system may also receive synchronization requests from a user of the service. The synchronization requests may indicate requested data and a list of processing operations. The requested data may correspond to data received from multiple data vendors. The system may perform the list of processing operations and return the data. Accordingly, the system may manage data received from multiple data vendors even if the data vendors have different synchronization conditions and provide the data in different formats. The data may be analyzed and output together to a user.

This application claims the benefit of U.S. Provisional Application Number 62/588,729, filed on Nov. 20, 2017, which is incorporated by reference herein in its entirety.

### BACKGROUND

Some database systems allow users to receive data from a plurality of different data producers. However, synchronization may be difficult. For example, the data producers may use different formats or labels, making it difficult for a user to cross-reference data sets from different data producers. As another example, the data producers may update their data sets at different times, which may make it difficult for users to tell if their data set is up to date.

### BRIEF DESCRIPTION OF THE DRAWINGS

FIG. 1 is a block diagram illustrating an exemplary multi-vendor synchronization platform, according to some embodiments.

FIG. 2 is a block diagram illustrating an exemplary ingestion process, according to some embodiments.

FIG. 3 is a block diagram illustrating an exemplary match process, according to some embodiments.

FIG. 4 is a flow diagram illustrating an exemplary process of managing a multi-vendor synchronization platform, according to some embodiments.

FIG. 5 is a block diagram illustrating an exemplary multi-tenant database system including a multi-vendor synchronization platform, according to some embodiments.

FIG. 6 is a block diagram illustrating an exemplary multi-tenant database system in more detail, according to some embodiments.

FIG. 7 is a block diagram illustrating an embodiment of a computing system that includes at least a portion of a multi-vendor synchronization platform.

This specification includes references to various embodiments, to indicate that the present disclosure is not intended to refer to one particular implementation, but rather a range of embodiments that fall within the spirit of the present disclosure, including the appended claims. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “processing element configured to verify access permissions” is intended to cover, for example, an element that performs this function during operation, even if the circuit in question is not currently being used (e.g., power is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function. After appropriate programming, the FPGA may then be configured to perform that function.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a computer system that includes six data objects, the terms “first data object” and “second data object” can be used to refer to any two of the six data objects, and not, for example, just logical data objects zero and one.

When used in the claims, the term “or” is used as an inclusive or and not as an exclusive or. For example, the phrase “at least one of x, y, or z” means any one of x, y, and z, as well as any combination thereof (e.g., x and y, but not z).

In the following description, numerous specific details are set forth to provide a thorough understanding of the disclosed embodiments. One having ordinary skill in the art, however, should recognize that aspects of disclosed embodiments might be practiced without these specific details. In some instances, well-known circuits, structures, signals, computer program instruction, and techniques have not been shown in detail to avoid obscuring the disclosed embodiments.

### DETAILED DESCRIPTION

The present disclosure describes techniques for ingesting, storing, and processing data for users in an extensible manner based on associated metadata. In various embodiments described below, data stored at a service (e.g., a multi-tenant database service) is automatically synchronized with a plurality of data vendors or other data sources. At least some of the data vendors may have different synchronization conditions (e.g., synchronization schedules). Further, the data from the data vendors may have different formats. The service may parse the data based on associated metadata and may store the data based on a universal data format of the service. In response to a request from a user, the service may perform various operations on data indicated by the user and may send the indicated data to the user. In some embodiments, the indicated data may be sent to the user in a custom format indicated by the user. As a result, the service may ingest and update data vendor datasets having a variety for formats and synchronization conditions. Further, the user may specify various operations to be performed and may receive the data in a requested format.

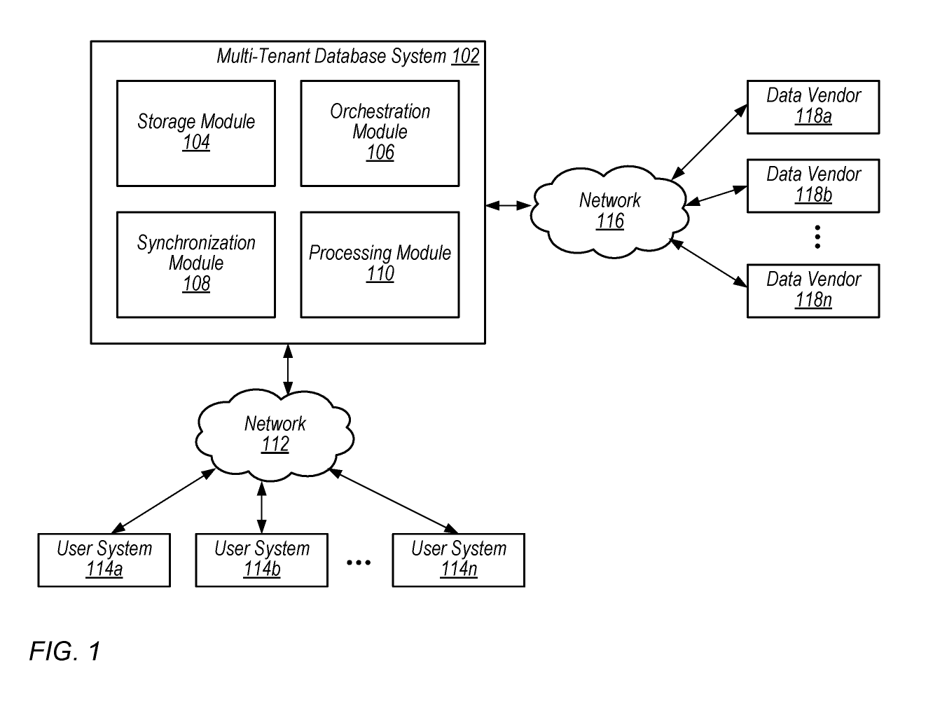

Turning now to FIG. 1, a block diagram of a multi-vendor synchronization platform is shown. In the illustrated embodiment, a multi-tenant database system 102, a plurality of user systems 114a-n, a plurality of data vendors 118a-n, and networks 116 and 118 are shown. Multi-tenant database system 102 includes storage module 104, orchestration module 106, synchronization module 108, and processing module 110. In some embodiments, network 112 and 116 may be connected to each other or may be the same network (e.g., a private network or the Internet). In some embodiments, multi-tenant database system 102 may be a single tenant database system (e.g., a database system for only user system 114b). In some embodiments, data vendors 118a-n may be data sources (e.g., databases).

In the illustrated embodiment, multi-tenant database system 102 may include one or more computer systems and may implement a service. The service may store data of data vendors 118a-n at storage module 104 (e.g., a single storage device or a plurality of storage devices). In response to a respective synchronization condition (e.g., a particular amount of time elapsing, receiving a request from a user, receiving a request from a data vendor, corresponding data indicating a synchronization condition, or another synchronization condition) being satisfied, multi-tenant database system 102, via synchronization module 108, may synchronize a portion of the data stored at storage module 104 with data from a corresponding data vendor (e.g., data vendor 118a). In some cases, synchronizing the data may include receiving additional data from the corresponding data vendor. The data may be sent in a format of the data vendor. The data may be sent with corresponding metadata. The metadata may indicate information about the format of the data. Synchronization module 108 may indicate, to processing module 110, locations of various data entries. Processing module 110 may use the locations to store portions of the data in corresponding portions of a universal data format of the service. Accordingly, multi-tenant database system 102 may automatically synchronize stored data with data of data vendors 118a-n.

In various embodiments, different data vendors (e.g., data vendors 118a and 118b) may send data to multi-tenant database system 102 in different formats. Additionally, in some cases, different data vendors may send data to multi-tenant database system 102 using different naming conventions or including different types of data. The service may coordinate with a data vendor (e.g., data vendor 118b) to agree upon a set of data values that the data may include. Further, the service may coordinate with the data vendor to agree how the fields may be indicated by the corresponding metadata. In some embodiments, data vendors 118a-n may correspond to a plurality of respective entities. For example, data vendors 118a and 118c may correspond to a first entity and data vendor 118b may correspond to a second entity. In some embodiments, multi-tenant database system 102 may correspond to a separate entity from at least some of data vendors 118a-n. For example, multi-tenant database system 102 may correspond to a different entity than the entities associated with all of data vendors 118a-n or multi-tenant database system 102 may correspond to an entity associated with data vendors 118a and 118c but not data vendors 118b or data vendors 118d-n.

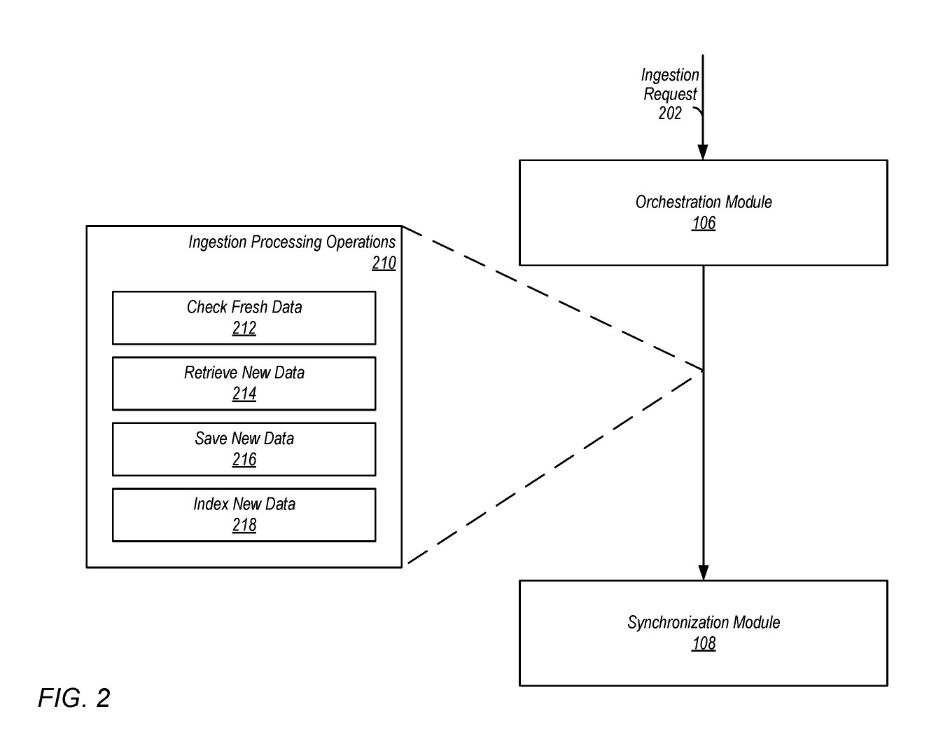

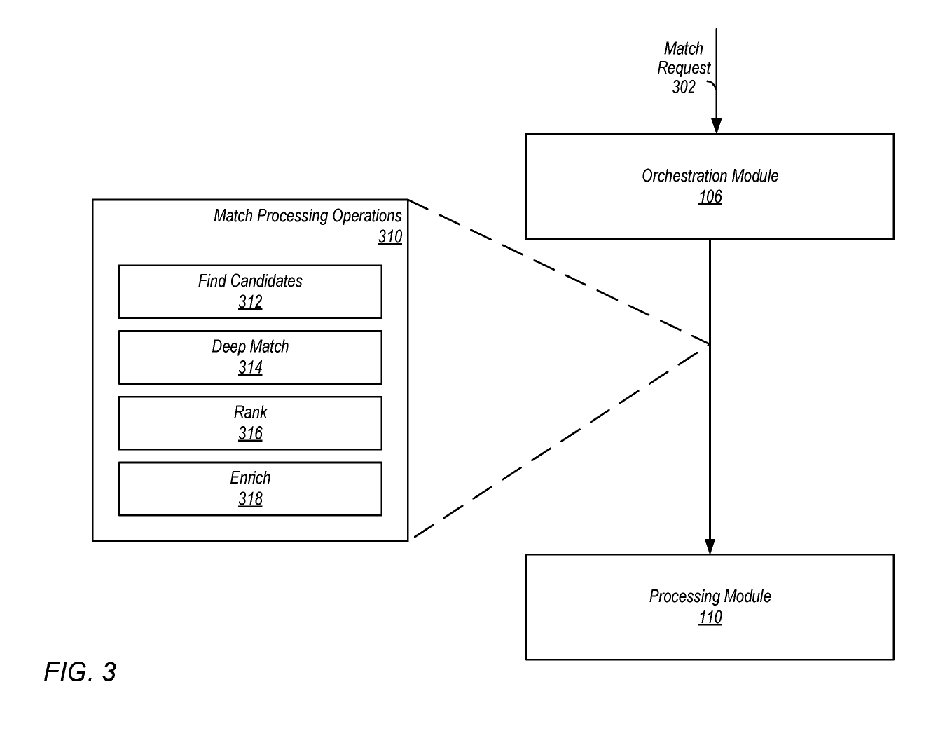

User systems 114a-n may send synchronization requests to multi-tenant database system 102. As further discussed below with reference to FIGS. 2 and 3, the synchronization requests may include one or more of of several different types of requests, including ingestion requests, match requests, discovery requests, or recommend requests. The synchronization requests may refer to data corresponding to multiple different data vendors (e.g., data vendors 118a and 118n). Because the data is stored in the universal storage format, multi-tenant database system 102 may provide corresponding results from multiple data vendors that use different data formats. Orchestration module 106 may determine, based on the synchronization request, a list of processing operations (e.g., checking with the corresponding data vendor(s), performing a search of the data, ranking various data entries, etc.) for to be performed on the data. Orchestration module 106 may instruct processing module 110 to perform the processing operations. In some cases, the synchronization requests may include indications of various requested operations to be performed with regard to at least a portion of the data. Additionally, in some cases, orchestration module 106 may predict operations for a user system and may, based on the predictions, add operations to the list of processing operations. For example, if a request type is not specified, in some embodiments, orchestration module may treat the synchronization request as a match request and may add one or more processing operations to the list of processing operations specified by the synchronization request. Further, orchestration module 106 may be taught to identify requests for additional processing operations. Similarly, processing module 110 may be taught to perform the additional processing operations. Accordingly, the list of potential processing operations that can be requested by user systems 114a-n may be extensible. Further, in some cases, the synchronization requests may include instructions from several different types of requests, which, in some cases, may result in customized functionality.

In some cases, a synchronization request may request a custom format for data provided in response to the synchronization request. Processing module 110 may convert the data into the custom format. As a result, in some embodiments, a user system (e.g., user system 114a) may receive processed results of synchronized data from multiple data vendors having different formats and different synchronization conditions without storing all of the data from data vendors 118a-n.

Further particular embodiments are described in the figures described below. The additional embodiments may be used in addition to the system of FIG. 1 or separately from the system of FIG. 1.

Turning now to FIG. 2, an exemplary ingestion process performed by a multi-vendor synchronization platform is shown. In the example, ingestion request 202 is received by orchestration module 106. In the illustrated embodiment, ingestion request 202 includes a list of requested processing operations. In some embodiments, the list of requested processing operations may comprise a request for a data synchronization operation. Orchestration module 106 may receive the list of requested processing operations and may generate, based on the list, ingestion processing operations 210. Further, based on the contents of ingestion request 202 (e.g., the requested processing operations), orchestration module 106 may determine that synchronization module 108 should receive an indication of some or all of ingestion processing operations 210. As discussed above, in some embodiments, orchestration module 106 may add various operations to the list of requested processing operations. In the illustrated embodiment, ingestion request 202 is received from a user (e.g., a user of user system 114a). However, in other embodiments, ingestion request 202 may be received from another source, such as data vendor 118b requesting an ingestion from itself into the multi-vendor synchronization platform.

In the illustrated embodiment, based on ingestion processing operations 210, synchronization module 108 may perform a requested ingestion operation with respect to at least one data vendor. Ingestion request 202 may identify the data vendor (e.g., data vendor 118b of FIG. 1). In the illustrated embodiment, ingestion processing operations 210 include checking for fresh data 212, retrieving new data 214, saving the new data 216, and indexing the new data 218. Accordingly, at 212, synchronization module 108 may communicate with data vendor 118b to check for new data. In response to identifying new data, at 214, synchronization module 108 may retrieve the new data from data vendor 118b. At 216, synchronization module 108 may save the new data at storage module 104. Finally, at 218, synchronization module 108 may index the new data for searching within storage module 104.

In other embodiments, fewer processing operations or additional processing operations may be performed. For example, prior to indexing the new data 218, synchronization module 108 may validate the new data (e.g., by checking for fresh data a second time). As another example, processing module 110 may run machine learning model generation on various steps (e.g., determining when to check for fresh data or determining how to index new data from a data vendor). As yet another example, various portions of the multi-vendor synchronization platform (e.g., synchronization module 108 or orchestration module 106) may call various external services to perform various operations mentioned herein (e.g., validating received data or transforming received data into a universal data format). Additionally, in some embodiments, various operations may be performed by different modules. For example, processing module 110 may index the data. In some embodiments, ingestion request 202 may be a synchronization request. Additionally, in some embodiments, ingestion request 202 may request at least some of the data retrieved by ingestion processing operations 210.

Turning now to FIG. 3, an exemplary match process performed by a multi-vendor synchronization platform is shown. In the example, match request 302 is received by orchestration module 106. In the illustrated embodiment, match request 302 includes a list of requested processing operations. In some embodiments, the list of requested processing operations may comprise a request for a data retrieval operation. Orchestration module 106 may receive the list of requested processing operations and may generate, based on the list, match processing operations 310. Further, based on the contents of match request 302 (e.g., the requested processing operations), orchestration module 106 may determine that processing module 110 should receive an indication of some or all of match processing operations 310. As discussed above, in some embodiments, orchestration module 106 may add various operations to the list of requested processing operations. In the illustrated embodiment, match request 302 is received from a user (e.g., a user of user system 114a). However, in other embodiments, match request 302 may be received from another source, such as data vendor 118b requesting an indication of what data is stored by the multi-vendor synchronization platform.

In the illustrated embodiment, based on match processing operations 310, processing module 110 may perform a requested match operation with respect to at least one search parameter. Match request 302 may identify the search parameter (e.g., a data value, a data type, or both). In the illustrated embodiment, match processing operations 310 include finding search candidates 312, performing a deep match on the search candidates 314, ranking the candidates identified by the deep match 316, and enriching the results 318. Accordingly, at 312, processing module 110 may search the data values stored at storage module 104 to find candidates that correspond to the search parameter. At 314, processing module 110 may perform a deep match on the candidates by analyzing data values associated with the candidates. At 316, processing module 110 may rank the identified candidates (e.g., based on relevance to the search parameter or based on when the candidates were entered into storage module 104). Finally, at 318, processing module 110 may enrich the match results by retrieving information corresponding to the identified data values and providing that information with the match results.

In other embodiments, fewer processing operations or additional processing operations may be performed. For example, subsequent to enriching the results 318, the results may be denormalized. As another example, results may be standardized (e.g., converting a country field from “US” or “USA” to “United States”). Additionally, in some embodiments, various operations may be performed by different modules. For example, in some embodiments, the match operation may be performed by storage module 104. In some embodiments, match request 302 may be a synchronization request (e.g., between data stored at a user system and data stored at storage module 104).

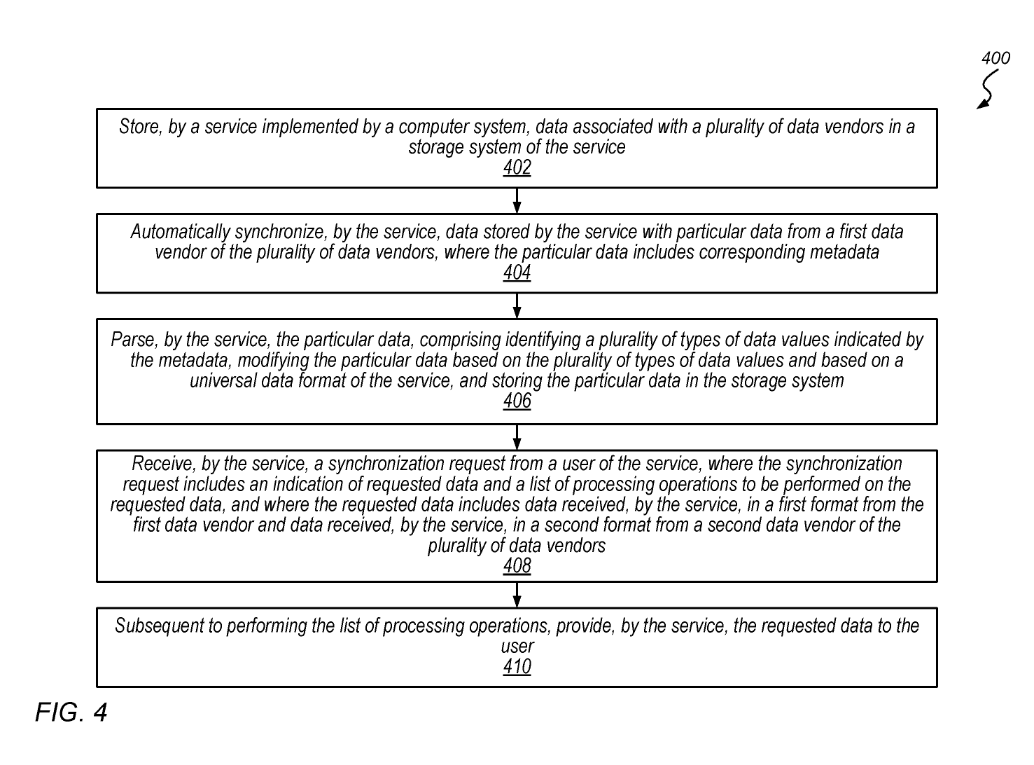

Referring now to FIG. 4, a flow diagram of a method 400 of managing a multi-vendor synchronization platform is depicted. In some embodiments, method 400 may be initiated or performed by one or more processors in response to one or more instructions stored by a computer-readable storage medium.

At 402, method 400 includes storing, by a service implemented by a computer system, data associated with a plurality of data vendors in a storage system of the service. For example, multi-tenant database system 102 may store data associated with data vendors 118a-n in storage module 104.

At 404, method 400 includes automatically synchronizing, by the service, data stored by the service with particular data from a first data vendor of the data vendors. The particular data may include corresponding metadata. For example, synchronization module 108 may automatically synchronize data stored at storage module 104 with data stored at a first data vendor (e.g., data vendor 118a). In some embodiments, the data may be synchronized based on a synchronization condition.

At 406, method 400 includes parsing, by the service, the particular data, comprising identifying a plurality of types of data values indicated by the metadata, modifying the particular data based on the plurality of types of data values and based on a universal data format of the service, and storing the particular data in the storage system. For example, processing module 110 may identify types of data values indicated by metadata, and may use the identified types of data to modify the received data into a universal data format. The modified data may be stored at storage module 104.

At 408, method 400 includes receiving, by the service, a synchronization request from a user of the service. The synchronization request may include an indication of requested data and a list of processing operations to be performed on the requested data. The requested data may include data received, by the service, in a first format from the first data vendor. The requested data may also include data received, by the service, in a second format from a second data vendor of the plurality of data vendors. For example, orchestration module 106 (or another module) may receive an ingestion request, a match request, a discovery request, or a recommend request (e.g., from a user system), where the request includes an indication of requested data and a list of processing operations (e.g., ingestion processing operations 210 or match processing operations 310). Additionally, in some cases, the synchronization request may indicate processing operations associated with various different types of requests. In the example, the requested data is received from multiple data vendors in respective data formats.

At 410, method 400 includes, subsequent to performing the list of processing operations, providing, by the service, the requested data to the user. For example, synchronization module 108 (or another module) may provide the requested results to the user system. Accordingly, a method of managing a multi-vendor synchronization platform is depicted.

### Exemplary Multi-Tenant Database System

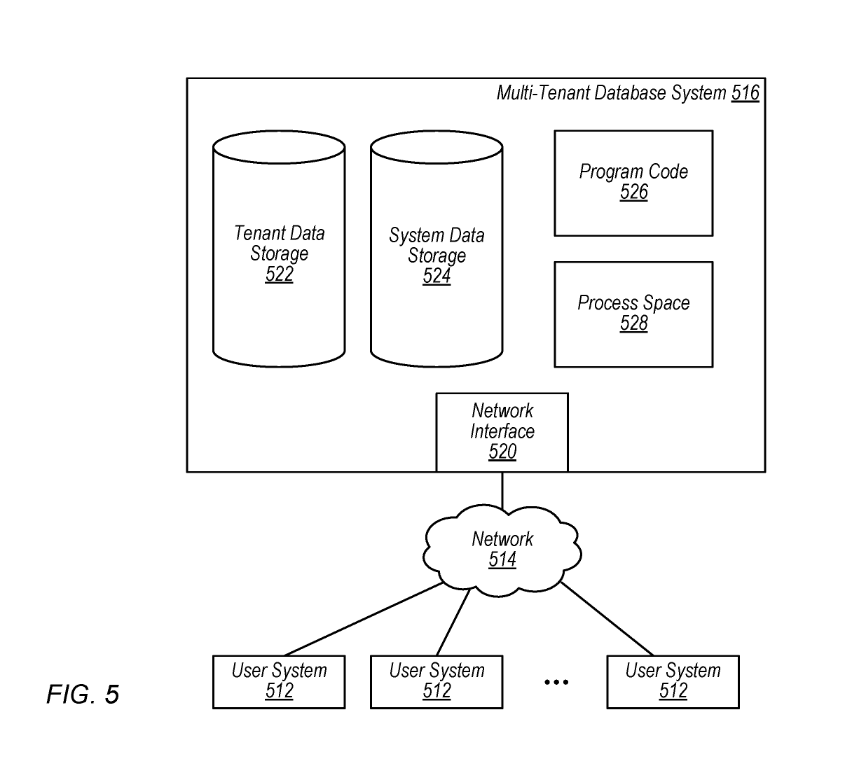

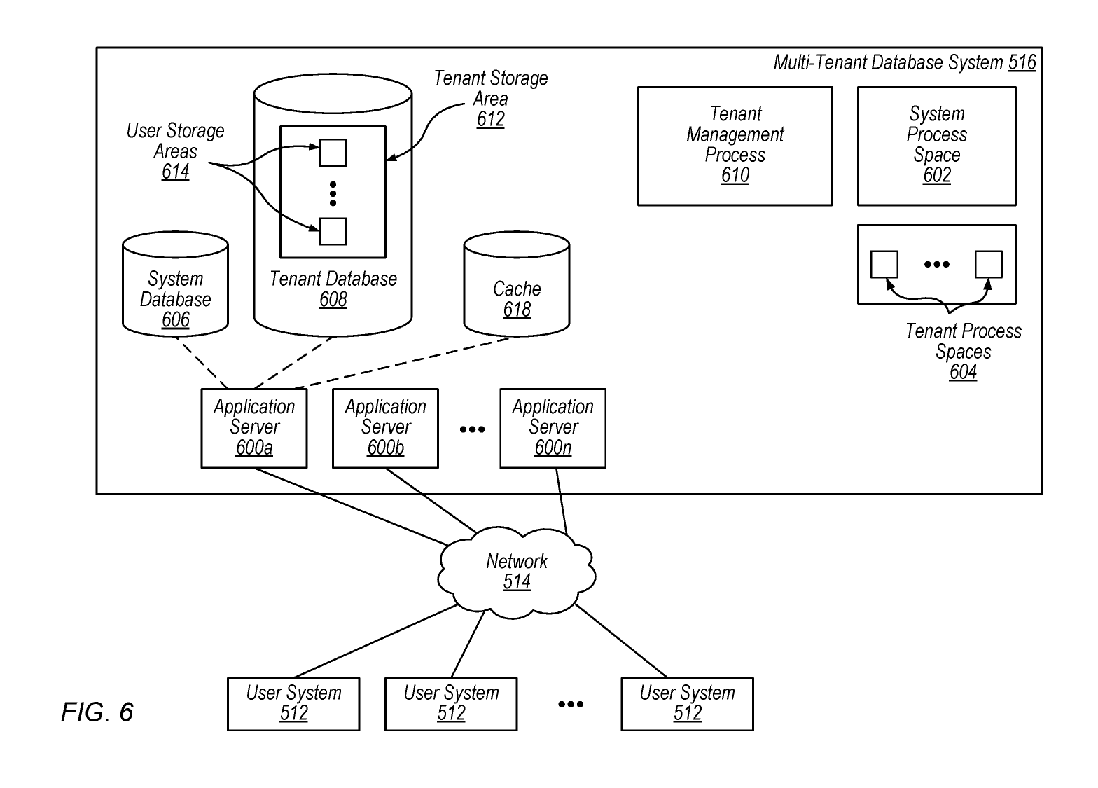

FIG. 5 illustrates an exemplary environment in which a multi-tenant database and cache system might be implemented. Note that the disclosed multi-tenant systems are included to illustrative purposes but are not intended to limit the scope of the present disclosure. In other embodiments, similar techniques may be implemented in non-multi-tenant environments such as various client/server environments, cloud computing environments, clustered computers, etc. As illustrated in FIG. 5 (and in more detail in FIG. 6) one or more user systems 512 may interact via a network 514 with a multi-tenant database system (MTS) 516, which may be multi-tenant database system 102. The users of those user systems 512 may be users in differing capacities and the capacity of a particular user system 512 might be determined by the current user. For example, when a salesperson is using a particular user system 512 to interact with MTS 516, that user system 512 may have the capacities allotted to that salesperson. However, while an administrator is using the same user system 512 to interact with MTS 516, it has the capacities allotted to that administrator. Accordingly, in various embodiments, information (e.g., data from data vendors 118a-n) maintained by a system (e.g., system 110A) implementing multi-tenant database system 516 can be modified by only the users that have the appropriate capacities (e.g., permissions).

Network 514 may be a LAN (local area network), WAN (wide area network), wireless network, point-to-point network, star network, token ring network, hub network, or any other appropriate configuration. The global internetwork of networks often referred to as the “Internet” with a capital “I,” will be used in many of the examples herein and is one example of a TCP/IP (Transfer Control Protocol and Internet Protocol) network. It should be understood, however, that the networks that the present invention may utilize any of various other types of networks.

User systems 512 may communicate with MTS 516 using TCP/IP and, at a higher network level, use other common Internet protocols to communicate, such as HTTP, FTP, AFS, WAP, etc. As an example, where HTTP is used, user system 512 might include an HTTP client commonly referred to as a “browser” for sending and receiving HTTP messages from an HTTP server at MTS 516. Such a server might be implemented as the sole network interface between MTS 516 and network 514, but other techniques might be used as well or instead. In some implementations, the interface between MTS 516 and network 514 includes load sharing functionality, such as round-robin HTTP request distributors to balance loads and distribute incoming HTTP requests evenly over a plurality of servers. Preferably, each of the plurality of servers has access to the MTS's data, at least for the users that are accessing a server.

In some embodiments, the system shown in FIG. 5 implements a web-based customer relationship management (CRM) system. For example, in some embodiments, MTS 516 includes application servers configured to implement and execute CRM software applications as well as provide related data, code, forms, web pages and other information to and from user systems 512 and to store to, and retrieve from, a database system related data, objects and web page content. In embodiments of a multi-tenant system, tenant data is preferably arranged so that data of one tenant is kept separate from that of other tenants so that that one tenant does not have access to another tenant's data, unless such data is expressly shared.

One arrangement for elements of MTS 516 is shown in FIG. 5, including a network interface 520, storage 522 for tenant data, storage 524 for system data accessible to MTS 516 and possibly multiple tenants, program code 526 for implementing various functions of MTS 516, and a process space 528 for executing MTS system processes and tenant-specific processes, such as running applications as part of an application service.

Several elements in the system shown in FIG. 5 may include conventional, well-known elements that need not be explained in detail here. For example, each user system 512 may be a desktop personal computer, workstation, laptop, PDA, cell phone, or any WAP-enabled device or any other computing device capable of interfacing directly or indirectly to the Internet or other network connection. User system 512 may execute an HTTP client, e.g., a browsing program, such as Microsoft's Internet Explorer™ browser, Netscape's Navigator™ browser, Opera's browser, or a WAP-enabled browser in the case of a cell phone, PDA or other wireless device, or the like, allowing a user (e.g., subscriber of a CRM system) of user system 512 to access, process, and view information and pages available to it from MTS 516 over network 514. Each user system 512 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 516 or other systems or servers. As discussed above, the present invention is suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

In some embodiments, each user system 512 and its components are operator configurable using applications, such as a browser, that include computer code executable on one or more processing elements. Similarly, in some embodiments, MTS 516 (and additional instances of MTSs, where more than one is present) and their components are operator configurable using application(s) that include computer code executable on one or more processing elements. Thus, various operations described herein may be performed by executing program instructions stored on a non-transitory computer-readable medium and executed by one or more processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the present invention can be implemented in any programming language that can be executed on a server or server system such as, for example, in C, C+, HTML, Java, JavaScript, or any other scripting language, such as VBScript.

According to one embodiment, each MTS 516 is configured to provide web pages, forms, applications, data, and/or media content to user systems 512 to support the access by user systems 512 as tenants of MTS 516. As such, in this embodiment, MTS 516 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, MTSs may include one or more logically and/or physically connected servers distributed locally or across one or more geographic locations. Additionally, the term “server” includes a computer system, including processing hardware and process space(s), and an associated storage system and database application as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence.

FIG. 6 illustrates exemplary embodiments of an MTS 516 and various interconnections in more detail. In this example, the network interface is implemented as one or more HTTP application servers 600. Also shown is system process space 602 including individual tenant process spaces 604, a system database 606, tenant database(s) 608 and a tenant management process space 610. Tenant database 608 may be shared across application servers and may be divided into individual tenant storage areas 612, which can be either a physical arrangement or a logical arrangement. Within each tenant storage area 612, user storage 614 might be allocated for each user.

In the illustrated embodiment, each application server 600 also includes at least a portion of a cache 618. In some embodiments, user systems 512 that utilize web applications can request that data be stored in cache 618 (e.g., using a “put” operation) and later retrieve the data (e.g., using a “get” operation) rather than re-generating the data. In some embodiments, capacity limits may be assigned to different users/tenants/partitions, etc. and cached data may be evicted in order to remain below the allotted capacity. In some embodiments, cached data for a particular tenant is kept private from other tenants. Further, the visibility scope for cached data within a particular tenant may be configurable.

In some embodiments, cache 618 is split across multiple application servers 600. In some embodiments, splitting across multiple instances may allow the data in cache 618 to fit in system memory space, which may improve response times relative to storing data for cache 618 in disk storage, for example. As used herein, an “in-memory cache” is a cache that stores data in system memory space (which typically means that the data can be stored in RAM) rather than requiring paging for storage (as is typically required for traditional disc storage, for example). Cache 618 may also be a “multi-tenant” cache in the sense that a single cache is used to provide separate virtual caches for multiple different tenant entities. The different tenants may use the same data structure to store data or different tenants may have different data structures in the cache. In various embodiments, multi-tenant caches enforce data security between tenants such that data from one tenant is not available to other tenants. Thus, as used herein, the term “tenant” in the context of a multi-tenant cache refers to an entity for which cache entries are separately maintained such that different tenants cannot access each other's data. In some embodiments, tenants may authorize other tenants to access their data via the cache, while in other embodiments a given tenant's data may be accessible to only that tenant via the multi-tenant cache (although that tenant may subsequently share data retrieved from the cache, as that tenant desires).

It should also be understood that each application server 600 may be communicably coupled to database systems, e.g., system database 606 and tenant database(s) 608, via, a different network connection. For example, one server 600a might be coupled via the Internet, another server 600b might be coupled via a direct network link, and another server 600n might be coupled by yet a different network connection. Transfer Control Protocol and Internet Protocol (TCP/IP) are preferred protocols for communicating between servers 600 and the database system, however, it will be apparent to one skilled in the art that other transport protocols may be used to optimize the system depending on the network interconnect used.

In preferred aspects, each application server 600 is configured to handle requests for any user/organization. Because it is desirable to be able to add and remove application servers from the server pool at any time for any reason, there is preferably no server affinity for a user and/or organization to a specific application server 600. In one embodiment, therefore, an interface system (not shown) implementing a load balancing function (e.g., an F5 Big-IP load balancer) is communicably coupled between the servers 600 and the user systems 512 to distribute requests to the servers 600. In one aspect, the load balancer uses a least connections algorithm to route user requests to the servers 600. Other examples of load balancing algorithms, such as are round robin and observed response time, also can be used. For example, in certain aspects, three consecutive requests from the same user could hit three different servers, and three requests from different users could hit the same server. In this manner, MTS 516 is multi-tenant, wherein the MTS 516 handles storage of different objects and data across disparate users and organizations.

As an example of storage, one tenant might be a company that employs a sales force where each salesperson uses MTS 516 to manage their sales process. Thus, a user might maintain contact data, leads data customer follow-up data, performance data, goals and progress data, all applicable to that user's personal sales process (e.g., in tenant database 608). In some MTS embodiments, since all of this data and the applications to access, view, modify, report, transmit, calculate, eta, can be maintained and accessed by a user system having nothing more than network access, the user can manage his or her sales efforts and cycles from any of many different user systems. For example, if a salesperson is paying a visit to a customer and the customer has Internet access in their lobby, the salesperson can obtain critical updates as to that customer while waiting for the customer to arrive in the lobby.

While each user's sales data may be separate from other users' sales data regardless of the employers of each user, some data may be organization-wide data shared or accessible by a plurality or all of the sales three for a given organization that is a tenant. Thus, there may be some data structures managed by MTS 516 that are allocated at the tenant level while other data structures are managed at the user level. Because an MTS may support multiple tenants including possible competitors, the MTS should have security protocols that keep data, applications and application use separate. Also, because many tenants will opt for access to an MTS rather than maintain their own system, security, redundancy, up-time and backup are more critical functions and need to be implemented in the MTS.

In addition to user-specific data and tenant-specific data, MTS 516 might also maintain system level data usable by multiple tenants. Such system level data might include industry reports, news, postings, and the like that are sharable among tenants.

In certain aspects, user systems 512 communicate with application servers 600 to request and update system-level and tenant-level data from MTS 516 that may require one or more queries to system database 606 and/or tenant database 608. In some embodiments, MTS 516 automatically generates one or more SQL statements (the SQL query) designed to access the desired information.

Each database may generally be viewed as a set of logical tables containing data fitted into predefined categories. Each table typically contains one or more data categories logically arranged in physical columns. Each row of a table typically contains an instance of data for each category defined by the columns. For example, a CRM database may include a table that describes a customer with columns for basic contact information such as name, address, phone number, fax number, etc. Another table may describe a purchase order, including columns for information such as customer, product, sale price, date, etc.

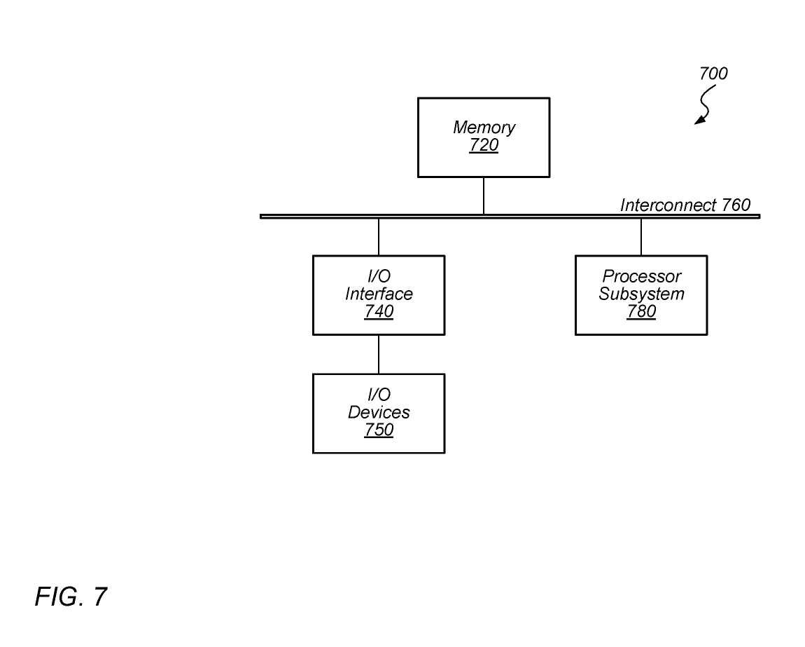

Turning now to FIG. 7, a block diagram of an exemplary computer system 700, which may implement multi-tenant database system 102, is depicted. Computer system 700 includes a processor subsystem 780 that is coupled to a system memory 720 and I/O interfaces(s) 740 via an interconnect 760 (e.g., a system bus). I/O interface(s) 740 is coupled to one or more I/O devices 750. Computer system 700 may be any of various types of devices, including, but not limited to, a server system, personal computer system, desktop computer, laptop or notebook computer, mainframe computer system, tablet computer, handheld computer, workstation, network computer, a consumer device such as a mobile phone, music player, or personal data assistant (PDA). Although a single computer system 700 is shown in FIG. 7 for convenience, computer system 700 may also be implemented as two or more computer systems operating together.

Processor subsystem 780 may include one or more processors or processing units. In various embodiments of computer system 700, multiple instances of processor subsystem 780 may be coupled to interconnect 760. In various embodiments, processor subsystem 780 (or each processor unit within 780) may contain a cache or other form of on-board memory.

System memory 720 is usable store program instructions executable by processor subsystem 780 to cause computer system 700 perform various operations described herein. System memory 720 may be implemented using different physical memory media, such as hard disk storage, floppy disk storage, removable disk storage, flash memory, random access memory (RAM—SRAM, EDO RAM, SDRAM, DDR SDRAM, RAIVIBUS RAM, etc.), read only memory (PROM, EEPROM, etc.), and so on. Memory in computer system 700 is not limited to primary storage such as system memory 720. Rather, computer system 700 may also include other forms of storage such as cache memory in processor subsystem 780 and secondary storage on I/O Devices 750 (e.g., a hard drive, storage array, etc.). In some embodiments, these other forms of storage may also store program instructions executable by processor subsystem 780. In various embodiments, data stored by or data, that when executed by a processor, causes the processor to perform operations corresponding to storage module 104, orchestration module 106, synchronization module 108, processing module 110, or any combination thereof described above may be included within system memory 720.

I/O interfaces 740 may be any of various types of interfaces configured to couple to and communicate with other devices, according to various embodiments. In one embodiment, I/O interface 740 is a bridge chip (e.g., Southbridge) from a front-side to one or more back-side buses. I/O interfaces 740 may be coupled to one or more I/O devices 750 via one or more corresponding buses or other interfaces. Examples of I/O devices 750 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 700 is coupled to a network via a network interface device (e.g., configured to communicate over WiFi, Bluetooth, Ethernet, etc.).

This disclosure includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “node configured to execute an instance of a database management application” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible. Thus the “configured to” construct is not used herein to refer to a software entity such as an application programming interface (API).

The term “configured to” is not intended to mean “configurable to.” An unprogrammed FPGA, for example, would not be considered to be “configured to” perform some specific function, although it may be “configurable to” perform that function and may be “configured to” perform the function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

As used herein, the terms “first,” “second,” etc. are used as labels for nouns that they precede, and do not imply any type of ordering (e.g., spatial, temporal, logical, etc.) unless specifically stated. For example, in a computer system having eight storage locations, the terms “first” and “second” storage locations can be used to refer to any two of the eight storage locations.

As used herein, the term “based on” is used to describe one or more factors that affect a determination. This term does not foreclose the possibility that additional factors may affect a determination. That is, a determination may be solely based on specified factors or based on the specified factors as well as other, unspecified factors. Consider the phrase “determine A based on B.” This phrase specifies that B is a factor is used to determine A or that affects the determination of A. This phrase does not foreclose that the determination of A may also be based on some other factor, such as C. This phrase is also intended to cover an embodiment in which A is determined based solely on B. As used herein, the phrase “based on” is thus synonymous with the phrase “based at least in part on.”

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
storing, by a service implemented by a computer system, data associated with a plurality of data vendors in a storage system of the service;
automatically synchronizing, by the service, data stored by the service with particular data from a first data vendor of the plurality of data vendors, wherein the particular data includes corresponding metadata;
parsing, by the service, the particular data, comprising:
identifying a plurality of types of data values indicated by the metadata;
modifying the particular data based on the plurality of types of data values and based on a universal data format of the service; and
storing the particular data in the storage system;
receiving, by the service, a synchronization request from a user of the service, wherein the synchronization request includes an indication of requested data and a list of processing operations to be performed on the requested data, and wherein the requested data includes data received, by the service, in a first format from the first data vendor and data received, by the service, in a second format from a second data vendor of the plurality of data vendors; and
subsequent to performing the list of processing operations, providing, by the service, the requested data to the user.

2. The method of claim 1, wherein the data is automatically synchronized in response to a first synchronization condition of the first data vendor being satisfied.

3. The method of claim 2, further comprising automatically synchronizing data stored by the service with data from the second data vendor in response to a second synchronization condition of the second data vendor being satisfied, wherein the second synchronization condition differs from the first synchronization condition.

4. The method of claim 3, wherein the first synchronization condition is a first amount of time elapsing after the service synchronizing data stored by the service with data stored by the first data vendor, and wherein the second synchronization condition is a second amount of time elapsing after the synchronizing data stored by the service with data stored by the second data vendor.

5. The method of claim 1, further comprising receiving, from the first data vendor, an indication of a type of data to be indicated by metadata associated with future data from the first data vendor.

6. The method of claim 1, wherein the synchronization request specifies a custom format for the requested data.

7. The method of claim 1, wherein the list of processing operations indicates a plurality of operations of a list of potential processing operations stored by the service.

8. The method of claim 1, further comprising the service predicting, based on a profile of the user, a processing operation, and adding the processing operation to the list of processing operations.

9. The method of claim 1, wherein the service is associated with a particular entity, and wherein the plurality of data vendors are associated with different entities that are distinct from the particular entity.

10. The method of claim 1, wherein the computer system is part of a multi-tenant on-demand database system, and wherein the service is a multi-tenant database service.

11. A non-transitory computer-readable storage medium having computer instructions stored thereon that, when executed by a computer system, cause operations comprising:
storing, in a storage system, data associated with a plurality of data vendors;
synchronizing data stored in the storage system with particular data received from a first data vendor of the plurality of data vendors, wherein the particular data includes corresponding metadata, comprising:
identifying a plurality of types of data values indicated by the metadata;
modifying the particular data based on the plurality of types of data values and based on a universal data format of the computer system; and
storing the modified particular data in the storage system;
receiving, from a user, a data request, wherein the data request includes an indication of requested data from the storage system and a list of processing operations to be performed on the requested data, and wherein the requested data includes data received, by the computer system, in a first format from the first data vendor and data received, by the computer system, in a second format from a second data vendor of the plurality of data vendors; and
subsequent to performing the list of processing operations, providing the requested data to the user.

12. The non-transitory computer-readable storage medium of claim 11, wherein the operations further comprise:
synchronizing the data stored in the storage system with second data received from a second data vendor of the plurality of data vendors, wherein the second data includes second metadata, comprising:
identifying a second plurality of types of data values indicated by the second metadata;
modifying the second data based on the second plurality of types of data values and based on the universal data format of the computer system; and
storing the modified particular data in the storage system.

13. The non-transitory computer-readable storage medium of claim 12, wherein at least one of the second plurality of types of data values is one of the plurality of types of data values indicated by the metadata received from the first data vendor.

14. The non-transitory computer-readable storage medium of claim 11, further comprising determining whether a synchronization condition associated with the first data vendor is satisfied, wherein the data is synchronized in response to determining that the synchronization condition is satisfied.

15. The non-transitory computer-readable storage medium of claim 14, wherein determining whether the synchronization condition is satisfied comprises identifying the synchronization condition from a plurality of synchronization conditions associated with the first data vendor, wherein the synchronization condition is associated with the particular data.

16. A non-transitory computer-readable storage medium having computer instructions stored thereon that, when executed by a computer system, cause operations comprising:
storing, in a storage system, data associated with a plurality of data sources, wherein at least two of the plurality of data sources correspond to different respective entities;
synchronizing data stored in the storage system with particular data received from a first data source of the plurality of data sources, wherein the particular data includes corresponding metadata, comprising:
identifying a plurality of types of data values indicated by the metadata;
modifying the particular data based on the plurality of types of data values and based on a universal data format of the computer system; and
storing the modified particular data in the storage system;
receiving, from a user, a synchronization request, wherein the synchronization request includes an indication of requested data from the storage system and a list of processing operations to be performed on the requested data, and wherein the requested data includes data received, by the computer system, in a first format from the first data source and data received, by the computer system, in a second format from a second data source of the plurality of data sources; and
subsequent to performing the list of processing operations, providing the requested data to the user.

17. The non-transitory computer-readable storage medium of claim 16, wherein the storage system corresponds to a particular entity that is not associated with the plurality of data sources.

18. The non-transitory computer-readable storage medium of claim 16, wherein the list of processing operations indicates a plurality of operations of a list of potential processing operations stored by the storage system.

19. The non-transitory computer-readable storage medium of claim 16, wherein the operations further comprise predicting, based on a profile of the user, a processing operation, and adding the processing operation to the list of processing operations.

20. The non-transitory computer-readable storage medium of claim 16, wherein the computer system is part of a multi-tenant on-demand database system, and wherein the user is associated with a tenant of the multi-tenant database system.
